(19) United States
(12) Patent Application Publication
(10) Pub. No.: US 2009/0320740 A1
(43) Pub. Date: Dec. 31, 2009

(54) METHOD AND APPARATUS FOR RELOCATING AND SUPPORTING AN OBJECT

(75) Inventors: Peter John Hume, Wellington (NZ); John Joseph Woollett, Wellington (NZ)

Correspondence Address: Workman Nydegger;1000 Eagle Gate Tower, 60 East South Temple, Salt Lake City, UT, 84111, US

(73) Assignee: Nexus Developments Limited, Wellington (NZ)

(21) Appl. No.: 12/158,587

(22) PCT Filed: Dec. 22, 2006
(86) PCT No.: PCT/NZ2006/000338

§ 371 Date: Aug. 27, 2008

(30) Foreign Application Priority Data
Dec. 22, 2005 (NZ) 544347

(51) Int. Cl. G09F 17/00

(52) U.S. Cl. 116/173; 248/534

(57) ABSTRACT

An object 1, is secured to a distal part of a flexible elongate member 4 that is inserted into a hollow interior 3 of an elongate tubular constraint 2. An intermediate length portion of the member is constrained within the constraint. A force applied to a proximal part of the member is directed longitudinally toward the distal part, and transferred as a compressive internal force along the intermediate portion to move it longitudinally within the hollow constraint and to move the object to a new location at which the object can be supported. In a preferred embodiment, a flexible and resilient member is pushed up a tube having a slot extending along the tube. A flag secured to the top end of the member extends out through the slot. An operator at ground level can push the member and attached flag into and up the tube to raise and fly the flag at an elevated position.

### FIELD OF INVENTION

The present invention relates to methods and apparatus for relocating an object and then supporting the relocated object at the new location. The invention has application to the flying or hanging of objects such as visual display or advertising material, festive lighting or decorations, and projection screens, and has particular application to the flying of flags.

More particularly, the invention relates to a method and apparatus for deploying an object, for example a flag, including moving or raising the object or flag from a first to a second location, and supporting the object or flag at the second location.

Flags, banners, pennants, burgees, colours, ensigns, jacks and standards, and the like, are to be understood as included by either one of the terms ‘flag’ or ‘banner’, and the corresponding plural forms, when used in this specification which uses these terms generically.

### BACKGROUND

Flags have been known for many millennia, and have been flown from flagpoles, for example as a means of signalling a message, such as by semaphore, or indicating an identity, such as national flags or ensigns, or to merely draw attention, or as an aesthetic expression.

Flags are typically flown from an upstanding or outstanding staff, or flagpole, that may be, but is not necessarily, substantially vertical or horizontal. In general, flags have a ‘hoist’ edge at which the flag is supported. Flags can be flown with the hoist edge substantially vertical, such as when the flag is flown from a vertical flagpole, or inclined or horizontal. In the latter configurations, the suspended flag can remain unfurled, even in the absence of wind, or other air movement.

In one common arrangement, flags are hoisted up a flagpole by attachment of the upper end of the hoist edge of the flag to a clip on one bight of a halyard which has been previously configured to run over a sheave in an enclosed pulley at a truck at or near the head of the flagpole. The flag is then raised by pulling down on the other bight of the halyard.

The halyard system is vulnerable to misalignment or jamming of the halyard at the sheave. Furthermore, if one end of the halyard is inadvertently released, it can rise and the clip can lodge at the masthead pulley or, and particularly if no clip is used, one bight of the halyard may rise and pass over the sheave. Before another flag can be raised up the pole, the halyard clip must be retrieved from the top of the pole or the halyard re-threaded over the masthead sheave. This usually requires the use of a ladder or cherry-picker or the like to gain access to the elevated sheave.

Furthermore, the noise of a halyard, oscillated by wind to strike repetitively against the flagpole, can be annoying.

In other common arrangements, flags or banners are often deployed without halyards or sheaves, being fixed directly to attachment points on flagpoles, walls, or other constructions. Banners are also provided with large hems or sleeves that are open at least one end, and that can be slipped over the end of an upright or inclined or horizontally cantilevered staff, banner bracket arm, or flagpole. In these, and other, arrangements, the flags and banners are usually flown from elevated positions to improve their visibility and impact. The fitting of a flag to any elevated support often requires the use of a ladder, cherry-picker or the like to provide safe access to the elevated position. For example, hemmed banners flown in public spaces are often deployed over flagpoles cantilevered from streetlight standards. Not only is a ladder or cherry-picker often required, but often traffic or safety control measures are mandated by authorities when the flags are to be installed and flown over roadways or other public spaces.

It can therefore be time consuming and expensive to replace numbers of flags or banners, such as when they have become worn or outdated.

Similarly, the arrangement of visual display material, festive decorations and lights, or projection screens, microphones or loudspeakers in auditoria, for example, can be difficult when these objects are to be elevated to positions out of usual reach of persons working at floor or ground level, such as when these objects are to be hung from high ceilings, or from elevated positions on street poles, or the like.

### SUMMARY OF INVENTION

An object of at least one embodiment of the invention is to provide a flag or a method of flying a flag or other object that helps mitigate against at least some of the shortcomings of the prior art, or at least to provide the public with a useful choice.

Another object of at least one embodiment of the invention is to provide an apparatus or method for moving a flag or other object from a first location to a remote second location without using a halyard and without requiring personnel at the second location.

In a first aspect the invention may be broadly said to be a method for moving an object from a first location to a second location remote from the first location and for supporting the object at the second location, the method comprising:
securing the object to a distal part of a flexible elongate member;
inserting the elongate member into a hollow interior of an elongate tubular constraint so that an intermediate length portion of the elongate member, that is intermediate the distal part and a proximal part of the elongate member, is constrained within the hollow interior of the constraint;
applying an external force to the proximal part of the elongate member, the force being directed longitudinally along the elongate member toward the distal part, to thereby move the intermediate length portion of the elongate member longitudinally within the hollow interior of the tubular constraint and move the distal part of the elongate member so that the object moves from the first location to the second location; and
supporting the object at the second location;
   wherein the elongate member is adapted so that the applied force is transferred as a compressive internal force along the intermediate length portion of the elongate member to move the distal part of the elongate member.

In a second aspect the invention may be broadly said to be an apparatus for moving an object from a first location to a second location remote from the first location and for supporting the object at the second location, the apparatus comprising:
an elongate tubular constraint having a hollow interior; and
a flexible elongate member having a proximal part, a distal part to which, in use, the object is secured, and an intermediate length portion that is intermediate the proximal and distal parts and is located and constrained within the hollow interior of the tubular constraint;
   wherein the elongate member is adapted so that the distal part of the elongate member can be moved longitudinally by application of an external force applied to the proximal part of the elongate member and directed longitudinally along the elongate member toward the distal part, by transfer of the applied force as a compressive internal force along the intermediate length portion of the elongate member.

Either of the first or second aspects of the invention may include the following preferences, options or alternatives.

Preferably, the constraint is, or is attached to, a fixed construction. The distal part of the elongate member may be moved from inside the hollow interior of the constraint to outside the hollow interior of the constraint when the object is moved from the first location to the second location. Preferably, the hollow interior of the constraint opens at an elongate slot extending longitudinally along the constraint. The object, when at the first location, may be substantially outside the hollow interior of the constraint. A portion of the object may extend through the elongate slot when the object is at the first location.

Preferably, the distal part extends along a portion of the length of the elongate member. The object may be secured to the elongate member along that portion of the elongate member.

The distal part may include a cantilever, the object being at least in part supported outwardly by the cantilever when the object is supported at the second location.

The intermediate portion of the elongate member that is constrained within the hollow interior may comprise discrete length portions. These portions may be successively inserted into the hollow interior to be arranged therein end to end and to thereby transfer the applied force as a compressive internal force through each discrete length portion. Each discrete length portion is preferably flexibly connected to an adjacent one of the discrete length portions. Each discrete length portion may be substantially rigid.

The proximal part of the elongate member may be fixed to the constraint when the object is supported at the second location.

In one preferred embodiment, the object is a flag.

In a third aspect the invention may be broadly said to be a flag assembly comprising a flag and a flexible elongate member, wherein the flexible elongate member has a proximal part, a distal part and an intermediate length portion that is intermediate the proximal and distal parts, the flag is secured to the distal parts and the elongate member is adapted so that, when the intermediate length portion is constrained within a hollow interior of an elongate tubular constraint, an external force applied to the proximal part and directed longitudinally toward the distal part can be transferred as a compressive internal force along the intermediate length portion to move the distal part and the flag.

The invention may further be said to consist in any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

Preferred embodiments and methods of performing and utilising the invention will be further described, with reference to the accompanying figures, by way of example only and without intending to be limiting, wherein;

FIG. 1 shows a diagrammatic side view of a flag apparatus according to the current invention, with a flag raised to an elevated flying position,

FIG. 2 shows a diagrammatic side view of the flag apparatus of FIG. 1, with the flag at a lowered position,

FIG. 3 shows a diagrammatic side view of the flag and staff of the apparatus of FIGS. 1 and 2,

FIG. 4 shows a cross-sectional view of the flag apparatus as seen at lines A-A of FIGS. 1 and 2,

FIG. 5 shows a cross-sectional view of a first alternative flag apparatus according to the invention,

FIG. 6 shows a diagrammatic side view of a second alternative flag apparatus according to the invention,

FIG. 7 shows a diagrammatic side view of a third alternative flag apparatus according to the invention,

FIG. 8 shows a diagrammatic side view of a fourth alternative flag apparatus according to the invention,

FIG. 9 shows a diagrammatic side view of a fifth alternative flag apparatus according to the invention,

FIG. 10 shows a diagrammatic side view of a top portion of a sixth flag alternative apparatus according to the invention, and

FIG. 11 shows a diagrammatic side view of a seventh alternative flag apparatus according to the invention.

### DETAILED DESCRIPTION OF PREFERRED EMBODIMENTS

Referring to the figures it will be appreciated that the invention may be implemented in various forms and modes. The following description of a preferred embodiment of the invention is given by way of example only.

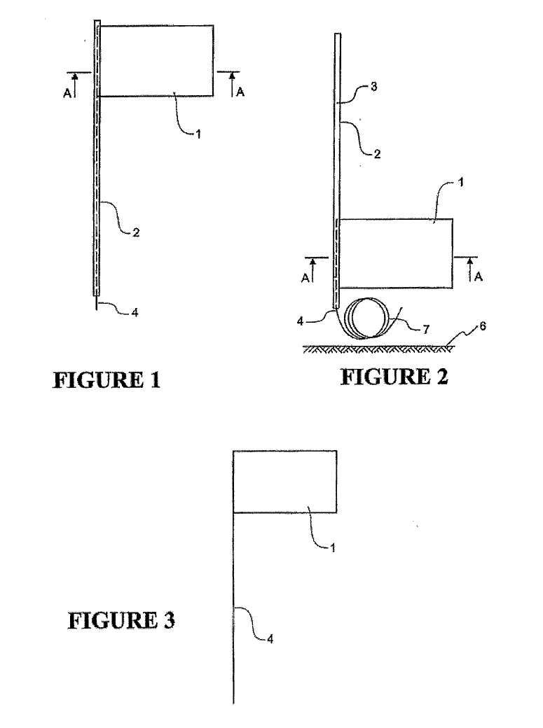

FIGS. 1 and 2 shows an apparatus for moving a flag 1 between a relatively low level at a first location and a higher level which is at a second location remote from the first location. FIG. 1 shows the flag raised and flying at the higher level whereas FIG. 2 shows the flag at the lower level.

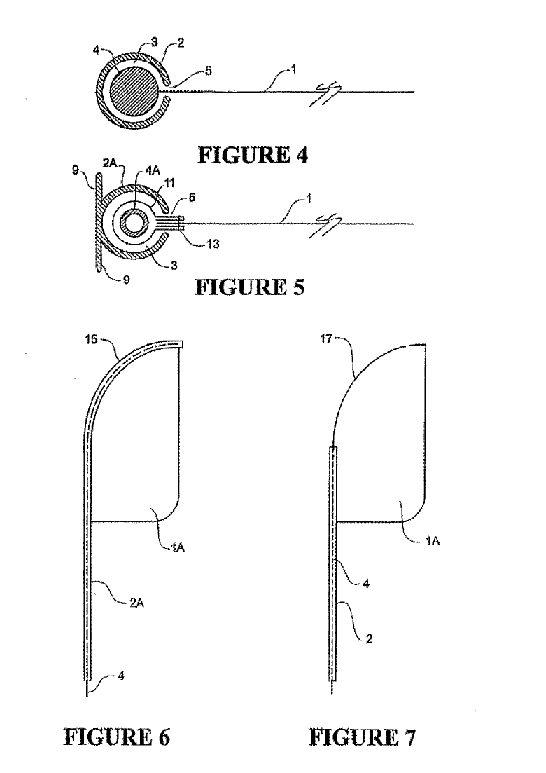

The apparatus comprises an elongate tubular guide track or constraint 2 having a hollow interior 3. The hollow interior may be best appreciated from the cross-sectional view shown in FIG. 4 which is as seen at line A-A of FIGS. 1 and 2. In this description and in the following claims, ‘tubular’ is to be understood as referring to a tube-like construction having walls which at least partially surround an interior hollow space. The walls of the tubular constraint do not necessarily close fully around the hollow space. There may be a longitudinal slot extending along at least part of the length of the tubular constraint, as will be explained further below.

The flag 1 is secured to a distal part of an elongate member 4 at its upper end. An intermediate length portion of the elongate member, between its upper and lower ends, is housed inside the hollow interior of the tubular constraint. This portion of the elongate member is concealed within the constraint and is shown in the figures by broken lines. In FIG. 1, the lower end of the elongate member is shown extending from the lower end of the tubular constraint.

FIG. 3 shows the flag 1 attached to the elongate member at a distal end portion at the upper end of the elongate member 4.

As best seen in the cross-sectional view of FIG. 4, the tubular constraint has a slot 5 through which the flag can extend from inside the hollow interior of the constraint to outside the constraint. The elongate member 4 has a diameter that is less than the internal diameter of the hollow interior while being greater than the width of the slot 5 so that the elongate member can be constrained within the hollow interior. The width of the slot is made wider than the thickness of the flag and any fasteners or fixings used to secure the flag to the elongate member. The elongate member and the flag and its fastenings and/or fixings slide easily in the constraint and in the slot.

The upper end of the elongate member 4, with the flag 1 attached, is fed into the hollow interior 3 at the lower end of the tubular constraint 2. In cases where the constraint is formed with the longitudinal slot 5, the flag can extend out through the slot.

The lower end of the constraint can be opened at a local widening of the slot, e.g. by bending outward or cutting away the edges of the slot to provide open access for insertion of the elongate member and flag into the hollow interior of the constraint.

The invention may be used to move the flag through a tubular constraint having no longitudinal slot or opening. In this case, the hollow interior of the constraint has sufficiently large dimensions to accommodate the flag within the constraint. The lower end, and more especially the remote upper end, of the hollow interior may be belled out, trumpet-like, to aid in guiding of the flag into the hollow interior of the constraint when raising and lowering the flag. The flag is flown by inserting the elongate member and the furled flag into the lower end of the hollow constraint; pushing the elongate member upward to raise the flag up through the constraint until the flag is completely above the upper end of the constraint. In that raised position the flag is supported by the upper end of the elongate member which extends from the constraint. The flag can unfurl when it is clear above the constraint. The flag is lowered by reversal of the procedure, the flag being pulled into the upper end of the hollow interior of the constraint when the elongate member is pulled downward.

The elongate member is flexible allowing it to be curved or coiled, as shown in FIG. 2. This is particularly advantageous in cases, such as shown in FIG. 2, where the lower end of the tubular constraint 2 is too close to a ground or floor level 6, leaving insufficient room to align a rigid straight elongate member for insertion into the lower end of the hollow interior of the tubular constraint.

FIG. 2 shows a flag 1 attached to a one-piece elongate member 4. At least a portion of the elongate member below the flag is flexible. This flexible elongate member portion is rolled up into a coil 7 prior to inserting the upper end of the elongate member, with the flag attached, into the hollow interior 3 at the lower end of the tubular constraint 2. The flag extends out through a longitudinal slot which extends along the whole length of the constraint.

The elongate member is pushed upward into the hollow interior of the constraint to slide the flag upward. As this is done the coil 7, being the lower end of the elongate member, is gradually uncoiled. The pushing and uncoiling are continued until the flag is in a raised position, such as is shown in FIG. 1.

In the current invention, the intermediate portion of the elongate member is located within the hollow interior of the tubular constraint and can be slid up and down while being constrained within the confines of the hollow interior. The externally applied force pushing upward on the elongate member at or below the lower end of the constraint is transferred upwardly as an internal compression force along the intermediate portion of the elongate member to raise the upper end of the elongate member and with it the attached flag. The elongate member resists the internal compression force established along the staff so that the staff can be pushed from one end to move the other end, of the staff, to which the flag is secured.

The elongate member is preferably substantially incontractible, in that its length remains substantially unchanged when the elongate member is subject to the longitudinal compressive force. It is also useful if the elongate member is substantially inextensible, allowing the flag to be lowered by pulling down on the proximal part of the elongate member.

The constraint constrains at least the intermediate length portion of the elongate member to follow the general shape of the constraint, thereby preventing the elongate member from bending excessively when under compression, and allowing the flag to be raised. In one advantageous embodiment, the flexibility of the elongate member allows it to readily bend, not only to be moved through any curvature of the constraint, but also to be coiled up into a relatively flat compact form for marketing and distribution of the flag and attached elongate member.

The elongate member is preferably resilient. The resilience of the elongate member may make the elongate member alone insufficiently stiff to support the flag at the second location. However, the elongate member can support the flag at the second location when the elongate member is located inside the tubular constraint.

In cases where the constraint has a longitudinal slot, the slot allows the flag to be moved upward, with a major portion of the flag outside the constraint, while the flag remains secured to the elongate member and the intermediate portion of the elongate member remains constrained within the hollow interior.

In this way the flag can be raised from a relatively low level position, such as within easy reach of a person standing safely at ground or floor level, to a relatively high elevated position well above the reach of persons at the lower level. The flag can thus be raised to a relatively high level without using the conventional flag and pole arrangement with a halyard running over a sheave fitted at the higher level, or without needing to lift a person up to the high level, such as on a cherry picker or ladder.

The flag 1 may be lowered, for example from the upper level as shown in FIG. 1 to the lower level as shown in FIG. 2, by a simple reversal of the flag raising procedure as described above, and without requiring anybody to access the upper level.

The tubular constraint may itself be fixed and free standing or it may be supported by attachment to a fixed construction (not shown in the figures), such as a pole, streetlamp standard, or the exterior or interior wall of a building, for example.

FIG. 5 shows a cross-sectional view of an alternative construction in which the constraint 2A has a pair of side flanges 9 which extend longitudinally along at least a part of the constraint and by which the constraint can be attached to a fixed construction by an adhesive or by fasteners such as screws, nails, staples or rivets. The flanges may present a flat surface, as shown in FIG. 5, for attachment of the constraint to a fixed flat surface, or may be transversely curved or longitudinally ribbed, not shown, to improve the stability of engagement of the constraint with a curved surface such as a round pole or standard.

The flag may be secured to the elongate member by any suitable means. FIG. 5 shows a cross-section of one method by which the flag 1 is secured to the elongate member 4A. An elongate binding or tape 11, longitudinally aligned with the elongate member, is wrapped around the elongate member with the longitudinal sides of the tape fastened by stitches 13 or other means to the hoist edge of the flag. Each side of the tape may be folded over, as shown in FIG. 5, to double the tape thickness at each side of the flag. The flag 1 is stitched or otherwise fastened between the two doubled tape layers to conceal the peripheral edges of the tape and to form a longitudinal pocket or sleeve in which the elongate member is located. The tape can be attached to the hoist edge of the flag and the elongate member then inserted into the pocket, or the tape can be wrapped around the elongate member as the tape is being attached to the flag.

The top of the pocket may be closed by simply stitching across the top end of the tape, or by folding the top end of the tape over and securing the fold by stitching. Alternatively, an end cap or ferrule, not shown, may be crimped or otherwise fastened at the top end of the tape to close the pocket or secure the tape to the elongate member. The lower end of the hoist edge of the flag may be secured to the elongate member.

In one preferred embodiment, the elongate member is housed in a sleeve formed by a binding tape attached along the hoist edge of the flag. The sleeve extends over the full length of the elongate member. Both ends of the sleeve are secured to the elongate member, for example by crimping. The sleeve can be tensioned to tension the hoist edge of the flag, and to provide a means of applying a downward pull on the flag when pulling down the elongate member to lower the flag.

Where the flag is to be hoisted to, and flown at, a curved portion of the constraint, the hoist edge of the flag is preferably shaped with a curve corresponding to the curve of the upper end of the constraint. FIG. 6 shows a flag 1A that has a hoist edge curved to match the curve of the upper portion 15 of the curved constraint 2A.

Where the flag is to be hoisted up a constraint that has a changing rate of curvature, for example as seen in the arrangement shown in FIG. 6 where the lower end of the constraint 2A is straight and the upper end 15 is curved, the flag 1A is preferably made from a stretchable material that can stretch to accommodate the change in curvature and thereby reduce the likelihood of jamming of the elongate member in the constraint that could occur if the flag was made from a relatively inelastic material.

The elongate member and flag can be pushed up inside the hollow interior of the constraint 2 to extend beyond the end of the constraint, for example as shown in FIG. 7. In this example, the elongate member 4 is semi-rigid or flexible and the flag 1A is made with a curved hoist edge. At the flying position, the top end portion 17 of the elongate member 4 droops under the weight and curvature of the flag 1A to at least approximately adopt the curvature of the hoist edge of the flag.

The constraint 2 may be rectilinear as shown in FIGS. 1 and 2, or may have at least a portion 15 that is curved as seen in the constraint 2A shown in FIG. 6. The flexibility of the elongate member allows the elongate member to bend to accommodate to the curve, or the change in curvature, as the elongate member is moved along the curved constraint.

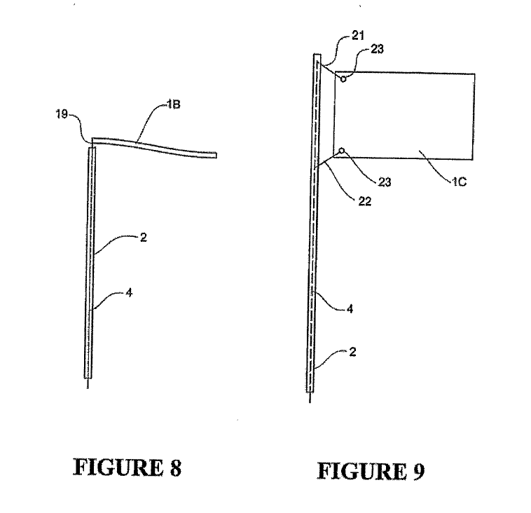

The flag is secured to the elongate member at or near the upper end of the elongate member. In some cases, for example the arrangement of the horizontally elongate flag 1B shown in FIG. 8, the flag is attached to the elongate member 4 at a single point 19.

In other cases, for example as shown in FIGS. 1, 2, 3, 6, 7 and 9, the attachment of the flag to the elongate member is distributed along a portion of the length of the elongate member. The attachment may be continuous along that portion, as in the arrangements shown in FIGS. 1, 2, 3, 6 and 7, or may be made at discrete spaced apart points, such as in the arrangement shown in FIG. 9, where the upper end of the hoist edge of the flag 1C is secured to the upper end of the elongate member 4 by an upper tie line 21 and the lower end of the hoist edge is secured to a lower point of the elongate member by a lower tie line 22. Any suitable number of tie lines may be used. The tie lines may be secured to respective eyelets 23 provided along the hoist edge of the flag.

Two or more flags may be secured to a common elongate member supported by a tubular constraint as described above. In one example, not shown in the figures, a row of flags may be hung in a row across a room in which a tubular constraint is carried up one wall and curved over to run across the room, such as across the ceiling for example. The flags are each secured to a common elongate member which is fed into the hollow interior of the constraint at a relatively low level at the wall to push the flags up the wall and outwardly across the room to hang downwardly.

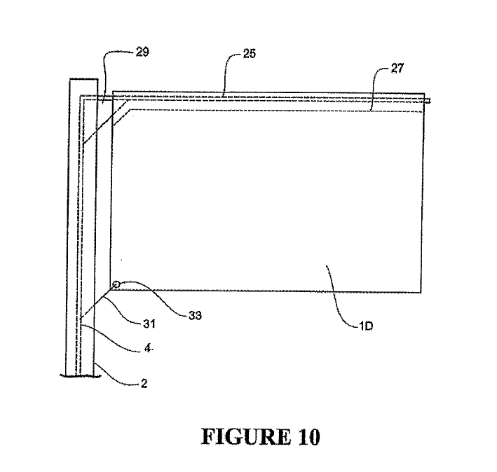

FIG. 10 shows a cantilever 25 at the top end of the elongate member 4. The flag 1D has a top edge hem 27 which is slipped over the cantilever. The cantilever is attached to the vertical section of the elongate member. The attachment of the cantilever to the elongate member is reinforced by a triangular gusset 29. A lower corner of the flag is secured to the elongate member by a tie line 31 attached to an eyelet 33 at the bottom of the hoist edge of the flag. The cantilever 25, gusset 29 and tie line 31, and their attachments to the elongate member, are each sufficiently thin so they can extend from the elongate member and out through a longitudinal slot in the tubular constraint 2. These outwardly extending components slide up and down the slot when the flag is raised and lowered. The cantilever holds the flag outwardly from the tubular constraint. This arrangement can be useful where there is insufficient wind to spread the flag, such as in indoor applications.

In a preferable arrangement, the elongate member is made as one length of a flexible plastics material. PVC has been found to be particularly suitable. Other suitable materials include metals, and resins or plastics, with or without reinforcement by fibres such as glass or carbon for example. The elongate member may be a tube or rod and may be extruded or pultruded from plastics or resin materials, optionally reinforced with fibres, such as glass or carbon fibres. In embodiments where the elongate member moving in the constraint is exposed, i.e. is not completely covered by the flag material or by a tape or other material used to secure the flag to the elongate member, then the elongate member preferably has a smooth outer surface so that the elongate member slides freely when pushed up inside the constraint.

The elongate member may have a solid cross section (such as the elongate member 4 seen in FIG. 4, for example) or it may be hollow (such as the tubular elongate member 4A shown in FIG. 5, for example). Although a round cross-section is shown in the figures, other non-circular cross-sectional shapes can be used. A relatively flat band, strip or bar may be particularly suitable in cases where differing bending characteristics in different planes is useful. The flatter cross-sections can provide an elongate member with increased flexibility in one plane without substantially compromising incontractibility.

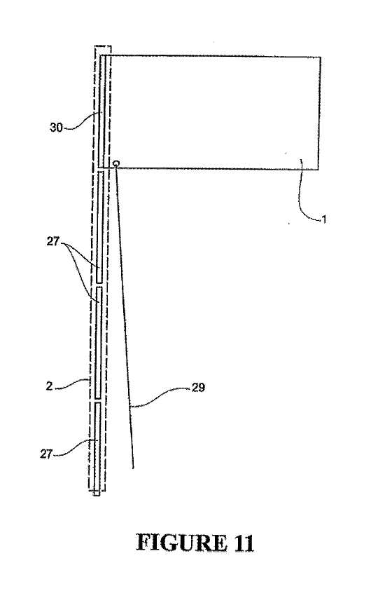

In FIG. 11, a portion of the elongate member is made up by discrete length portions 27. These length portions are fed sequentially into the bottom of the hollow interior of the tubular constraint 2 (shown by broken lines in FIG. 11). The length portions may be rigid or flexible.

The sub-division of the elongate member into a series of relatively short length portions, allows the use of rigid length portions where there is insufficient space to align a rigid single elongate member for insertion into the lower end of the constraint. The rigid length portions 27 are made shorter than the height of the lower end of the tubular constraint above the floor or ground level so that the length portions can be aligned for sliding insertion into the hollow interior of the constraint.

The discrete length portions 27 can be connected or joined together, end to end, such as by being encased in the extension of the folded and stitched tape 11 at the hoist edge of the flag, in the manner described above and as shown in FIG. 5. Any other suitable joining technique may be employed. For example, adjacent flexible length portions can be complementarily threaded and screwed, one into the other, as each one is brought in turn into alignment with a length portion already inserted into the constraint.

Alternatively, the discrete length portions 27 can be pivotally or flexibly connected to each other in an end-to-end chain-like configuration. The pivotal or flexible connection allows each length portion in turn to be brought into alignment with the constraint, ready for insertion into the hollow interior, while remaining connected together.

The connecting or linking together of the otherwise discrete length portions provides for application of a tension from the lower end of the elongate member to lower the flag. In cases where the length portions are not connected together, the flag may be lowered by pulling down on a tension line 29 attached to the flag, as shown in FIG. 11, or to the upper length portion 30 to which the flag is attached.

When the flag or flags have been raised and are at the elevated location ready for flying, the lower end of the elongate member can be fixed or secured to the constraint to hold the elongate member and the flag or flags in this position. The fixing can be by any suitable means, for example by a pin inserted through the tubular constraint at a point below, or through, the lower end portion of the elongate member. A locking device or a tamper resistant screw pin may be used to reduce the likelihood of unauthorised interference with, or removal of, the flag. One suitable locking device is a screw pin having a particular head shape made for engagement only by a complementarily-shaped blade of a specialised screw driver.

The foregoing describes the invention with reference to a preferred embodiment. Alterations and modifications as will be obvious to those skilled in the art are intended to be incorporated within the scope of the invention as defined in the accompanying claims. For example, although the preferred embodiments are generally described as for raising a flag from a low level to a higher level, the invention has equal applicability to the movement of a flag from a first location to a second location that is remote from the first, such as below, or horizontally spaced from, the first location.

Furthermore, the invention can be applied to flags and banners made from plastics, such as polyvinyl chloride (PVC), and to flags, banners and posters made from paper or based-based materials. The invention can be applied to flags and banners made from flexible or rigid materials. As examples of the latter, the invention may be applied to rigid signage made from card, lightweight plastics, or metal.

The invention can be applied to the moving of objects other than flags or banners. For example, festive decorations or strings of lights may be raised to, and supported at, elevated positions. The invention can be used to deploy a projection screen, or other audio-visual equipment such as microphones, loud speakers or stage lights, above an auditorium.

The invention is particularly advantageous where there is an ongoing need for objects to be raised to, supported at, and lowered from, elevated positions that would otherwise require ladders, scaffolding, cherry-pickers, or the like. Once installed, the invention allows for the successive deployment of objects at elevated positions by personnel remaining at floor or ground level.

The term ‘comprising’ as used in this specification and claims means ‘consisting at least in part of’, that is to say when interpreting statements in this specification and claims which include that term, the features, prefaced by that term in each statement, all need to be present but other features can also be present.

1-48. (canceled)

49. In an apparatus for moving an object from a first location to a second location remote from the first location and for supporting the object at the second location, the apparatus comprising:
an elongate tubular constraint having a hollow interior; and
a flexible elongate member having a proximal part, a distal part to which, in use, the object is secured, and an intermediate length portion that is intermediate the proximal and distal parts and is located and constrained within the hollow interior of the tubular constraint;
the improvement comprising the hollow interior of the constraint opening at an elongate slot which extends longitudinally along the constraint; and
the distal part of the elongate member being movable longitudinally by application of an external force applied to the proximal part of the elongate member and directed longitudinally along the elongate member toward the distal part, by transfer of the applied force as a compressive internal force along the intermediate length portion of the elongate member.

50. An apparatus as claimed in claim 49, wherein the constraint is, or is attached to, a fixed construction.

51. An apparatus as claimed in claim 49, wherein the distal part of the elongate member is moveable from inside the constraint to outside the tubular constraint to move the distal part from the first location to the second location.

52. An apparatus as claimed in claim 49, wherein the distal part includes a cantilever for supporting the object outwardly from the constraint.

53. An apparatus as claimed in claim 49, wherein the intermediate portion of the elongate member comprises a plurality of discrete length portions.

54. An apparatus as claimed in claim 53, wherein each discrete length portion is flexibly connected to an adjacent one of the discrete length portions, and each discrete length portion is substantially rigid.

55. An apparatus as claimed in claim 49, wherein the elongate member is resiliently flexible and substantially incontractible.

56. An apparatus as claimed in claim 49, wherein the elongate member is resiliently flexible and the flexibility of the elongate member makes the elongate member unable to support the object at the second location without support of the intermediate length portion of the elongate member by the tubular constraint.

57. An apparatus as claimed in claim 49, wherein the proximal part of the elongate member can be fixed to the constraint when the distal part is located for supporting the object at the second location.

58. In a flag assembly comprising a flag and a flexible elongate member, the flexible elongate member has a proximal part, a distal part and an intermediate length portion that is intermediate the proximal and distal parts, and the flag is secured to the distal part, the improvement comprising, when the intermediate length portion is constrained within a hollow interior of an elongate tubular constraint, an external force applied to the proximal part and directed longitudinally along the elongate member toward the distal part can be transferred as a compressive internal force along the intermediate length portion to move the distal part and the flag.

59. A flag assembly as claimed in claim 58, wherein the distal part extends along a portion of the length of the elongate member, and the flag is secured to the elongate member along that portion of the elongate member.

60. A flag assembly as claimed in claim 58, wherein the flag is secured to a cantilever at the distal part of the elongate member.

61. A flag assembly as claimed in claim 58, wherein the intermediate length portion comprises discrete length portions, each discrete length portion is resiliently connected to an adjacent one of the discrete length portions.

62. A flag assembly as claimed in claim 61, wherein each discrete length portion is substantially rigid.

63. A flag assembly as claimed in claim 58, wherein the elongate member is resiliently flexible and substantially incontractible.

64. A flag assembly as claimed in claim 58, wherein the elongate member is resiliently flexible and the flexibility of the elongate member makes the elongate member unable to support the flag without support of the intermediate length portion of the elongate member such as by being constrained within a hollow interior of an elongate tubular constraint.

65. A flag assembly as claimed in claim 58, wherein the flag has a hoist edge and the ends of the hoist edge of the flag are secured to the distal part of the elongate member.

66. A flag assembly as claimed in claim 65, wherein the flag has a sleeve along the hoist edge and the distal part of the elongate member lies inside the sleeve.

67. In a method for moving an object from a first location to a second location remote from the first location and for supporting the object at the second location, the method comprising:
securing the object to a distal part of a flexible elongate member; and
inserting the elongate member into a hollow interior of an elongate tubular constraint so that an intermediate length portion of the elongate member, that is intermediate the distal part and a proximal part of the elongate member, is constrained within the hollow interior of the constraint;
the improvement comprising applying an external force to the proximal part of the elongate member, the force being directed longitudinally along the elongate member toward the distal part, to thereby move the intermediate length portion of the elongate member longitudinally within the hollow interior of the tubular constraint and move the distal part of the elongate member so that the object moves from the first location to the second location; and
supporting the object at the second location;
wherein the hollow interior of the constraint opens at an elongate slot extending longitudinally along the constraint;
the object, when at the first location, is substantially outside the hollow interior of the constraint; and
the elongate member transfers the applied force as a compressive internal force along the intermediate length portion of the elongate member to move the distal part of the elongate member.

68. A method as claimed in claim 67, wherein the constraint is, or is attached to, a fixed construction.

69. A method as claimed in claim 67, wherein the distal part of the elongate member is moved from inside the hollow interior of the constraint to outside the hollow interior of the constraint when the object is moved from the first location to the second location.

70. A method as claimed in claim 67, wherein a portion of the object extends through the elongate slot when the object is at the first location.

71. A method as claimed in claim 67, wherein the distal part extends along a portion of the length of the elongate member, and the object is secured to the elongate member along that portion of the elongate member.

72. A method as claimed in claim 67, wherein the distal part includes a cantilever, and the object is at least in part supported outwardly from the constraint by the cantilever when the object is supported at the second location.

73. A method as claimed in claim 67, wherein a portion of the elongate member that is constrained within the hollow interior comprises discrete length portions which have been successively inserted into the hollow interior to be arranged therein end to end and to thereby transfer the applied force as a compressive internal force through each discrete length portion.

74. A method as claimed in claim 73, wherein each discrete length portion is flexibly connected to an adjacent one of the discrete length portions and each discrete length portion is substantially rigid.

75. A method as claimed in claim 67, wherein the elongate member is resiliently flexible and substantially incontractible.

76. A method as claimed in claim 67, wherein the elongate member is resiliently flexible and the flexibility of the elongate member makes the elongate member unable to support the object at the second location without support of the intermediate length portion of the elongate member by the tubular constraint.

77. A method as claimed in claim 67, wherein the proximal part of the elongate member is fixed to the constraint when the object is supported at the second location.

78. A method as claimed in claim 67, wherein the object is a flag.

79. A method as claimed in claim 78, wherein the flag has a hoist edge and the ends of the hoist edge of the flag are secured to the distal part of the elongate member.

80. A method as claimed in claim 79, wherein the flag has a sleeve along the hoist edge and the distal part of the elongate member lies inside the sleeve.
